(19) United States
(12) Patent Application Publication
(10) Pub. No.: US 2010/0281644 A1
(43) Pub. Date: Nov. 11, 2010

(54) Wiper arm extension

(76) Inventor: Curtis Taufman, Melville, NY (US)

Correspondence Address: Duane C. Blake, Esq.;Blake Legal Advisors, 67 Sterling Road, Westwood, MA, 02090, US

(21) Appl. No.: 12/008,834

(22) Filed: Jan. 14, 2008

Related U.S. Application Data
(63) Continuation-in-part of application No. 11/530,647, filed on Sep. 11, 2006, now abandoned.
Application No. 11/530,647 is a continuation-in-part of application No. 10/978,880, filed on Nov. 1, 2004, now Pat. No. 7,716,206.
(60) Provisional application No. 60/880,200, filed on Jan. 12, 2007.

(51) Int. Cl. B60S 1/34

(52) U.S. Cl. 15/250.31

(57) ABSTRACT

The present invention is a wiper arm extension subassembly which allows the use of the military vehicle's original equipment wiper motor and controls; and presumes that one or more anti-ballistic sheets, panes or panels having a thickness dimension not less than 0.5 inches in size are to be or have been installed in the vehicle. In its minimalist form, the present invention comprises only three component parts: (i) an extended flange; (ii) an extended crank arm; and (iii) an optionally present support bracket.

In the preferred embodiments, the wiper arm extension subassembly will replace the original equipment flange of the vehicle. This change is achieved by mounting the combined extended flange and extended crank arm to the military vehicle's pre-existing original equipment wiper motor and controls motor bracket; and by extending the length of the flange and crank arm for a greater (longer) distance to account for and accommodate the thickness dimension of the anti-ballistic windows, doors, dome, or other and visual viewing plates.

### CROSS-REFERENCES

This application is a Continuation of U.S. Provisional Application Ser. No. 60/880,200, filed Jan. 12, 2007, Continuation-In-Part of U.S. patent application Ser. No. 11/530,647 filed Sep. 11, 2006, now pending, which is a Continuation-In-Part of U.S. patent application Ser. No. 10/978,880 filed Jun. 29, 2004, now pending. The legal benefit and priority of these previously filed applications is expressly claimed, all of which are hereby incorporated by this application in their entireties.

### FIELD OF THE INVENTION

The present invention is concerned generally with improvements in wiper arms used with motorized vehicles having anti-ballistic egress windows, anti-ballistic visual doors, and anti-ballistic observation domes for visual observation and viewing in highly dangerous or military combat circumstances. All of the vehicular observation and viewing windows, doors and domes are themselves anti-ballistic—i.e., capable of protecting living subjects from a range and variety of moving objects which typically differ in size, shape and mass, which can travel at moderate to very high rates of speed, and which can cause serious injury or death as a consequence of physical impact with the body of a living subject. The improved wiper arm keeps the exterior surface(s) of these anti-ballistic viewing windows, doors and domes clean and clear in order that visual observation and viewing by the occupants of the vehicle remains unimpaired and unobstructed.

### BACKGROUND OF THE INVENTION

The present invention relates to enhancing the protection of living human and animal subjects which is provided through the use of anti-ballistic windows, anti-ballistic vehicular assemblies, and anti-ballistic transport manufactures—all of which use penetration-resistant window panes and panels for visual viewing and observation, and which are preferably laminated constructs prepared in advance and having a plurality of layers formed of asymmetric composite materials. These purposefully designed anti-ballistic windows, anti-ballistic vehicular assemblies, and anti-ballistic transport manufactures will protect their occupants from rapidly moving objects, such as high velocity projectiles and exploding fragments, under many different military circumstances and combat situations.

### The Anti-Ballistic Visual Viewing Plates

It will be appreciated that the anti-ballistic windows, doors and panels of a military vehicle are transparent or translucent plates having the capacity to withstand penetration by high velocity, small mass projectiles; and these anti-ballistic plates are manufactured in advance as individually formulated laminated composites which are then subsequently prepared as individual plates meeting pre-chosen engineering specifications. It is preferred that each anti-ballistic plate be a formulated laminated composite which comprises multiple layers of asymmetric composite materials joined in overlay series; and that one manufactured, these individually formulated laminated composites then are individually configured, sized, and optionally contoured as plates having pre-chosen engineering specifications in advance of their intended use as penetration-resistant windows, doors and panels in any vehicle.

Detailed descriptions of the preferred individually formulated laminated composites and the manner of preparing them as anti-ballistic plates having pre-chosen engineering specifications is disclosed by U.S. patent application Ser. No. 11/530,647 filed Sep. 11, 2006 and by U.S. patent application Ser. No. 10/978,880 filed Jun. 29, 2004 respectively, the texts of which are each expressly incorporated by reference herein. All of these anti-ballistic plate constructions can be advantageously employed in many different vehicular settings; in a diverse range of risk circumstances that vary greatly; and with particular modifications and engineering specifications which allow their immediate use as either original vehicular equipment or as a modification of a pre-existing vehicle with a minimum of difficulty by any person of ordinarily skill.

### The Nature of the Underlying Problem

While the anti-ballistic windows, doors and panels of military vehicles can be manufactured and will appear in many different formats, one basic and common problem shared among them how to keep the visual viewing area of such anti-ballistic windows, doors and domes clean and unobstructed, given the hazardous and often perilous circumstances of military and combat situations. Contrary to ordinary expectations, this problem is neither simple to understand nor easy to solve. Rather, to understand and appreciate the true difficulties properly, one must take into account the very nature and substance of the anti-ballistic laminated composites used today as anti-ballistic windows, doors and panels.

Initially, it will be recognized and appreciated that the overall force generated by a moving object at the time of its impact upon any formulated composition of matter or manufactured substance will largely vary with and depend upon two distinct factors, which are: (a) the object's physical qualities and intrinsic characteristics, such as its dimensions, volume, shape, mass (or weight), malleability, tensile strength, and hardness; and (b) the rate of speed or travel velocity for the moving object at the moment of impact.

Thus, for example, when evaluating penetration-resistance among similar thicknesses of the same substance, the capability to avoid being penetrated by an impact force will markedly deviate and vary when the moving object is one of the following: (i) a 2000 pound car driven at 45-95 miles per hour by an out-of-control driver; or (ii) a 8 foot length of 2×4 inch lumber moving between 100-125 miles per hour as a result of hurricane force winds; or (iii) a 9 millimeter lead bullet traveling at 2500-9000 feet per second after being fired from a hand gun.

Also, as an operational guideline, an object having a larger size and mass will typically travel at a relatively slow to moderate rate of speed, and thus will require a lesser degree of resistance property to prevent penetration of the material upon impact. Conversely, an object of smaller size and mass will often travel at a much greater rate of speed; and thus the protective material must demonstrate a much greater degree of penetration-resistance to avoid being pierced, punctured, perforated, fragmented, or shattered upon impact.

Accordingly, if the anti-ballistic material empirically demonstrates effective penetration-resistance to high-velocity projectiles of small mass and size, then it may be properly believed and expected that that test material will provide more than adequate penetration-resistance properties against the impact force generated by moving objects of larger size and mass.

Through prolonged empirical testing, it has been empirically determined that the preferred laminated composites are durable and effective in terms of their capabilities to withstand penetration by high velocity, small mass projectiles. This penetration-resistance capacity is illustrated and exemplified by the empirical data and details of Table 1 below.

TABLE 1

| Composite Materials | Projectiles | Tests | Weight | Thickness |
|---|---|---|---|---|
| AlfaClass.5.NS-SGP | 9 mm FMJ-1400 FPS | Exceeds UL, | 6.08 lbs | 0.50 inches |
| | | NIJ, HP White | | |
| AlfaClass75.NS-SGP | 357 Mag158 grs lead | Exceeds UL, | 6.75 lbs | 0.75 inches |
| | 1450 FPS | NIJ, HP White | | |
| AlfaClass.1.01.NS-PC | 44 Mag-240 gr lead | Exceeds UL, | 8.14 lbs | 1.01 inches |
| | 1470 FPS | NIJ, HP White | | |
| AlfaClass.1.01.NS-PC | 0.454 Casull 300 grs | Beyond Testing | 8.14 lbs | 1.01 inches |
| | lead 1550 FPS | Parameters | | |
| AlfaClass.1.01.NS-PC | 12 Ga. Shotgun | Exceeds UL, | 8.14 lbs | 1.01 inches |
| | Breneke Slugs | NIJ, HP White | | |
| Bravo Class. 1.243 NS-PC | 0.499 Mini 50 cal | 2 hits, six inches | 10.75 lbs | 1.2 inches |
| | express round | apart at 15′ | | |
| Bravo Class. 1.403. S-SGP | 5.56 NATO Round | 5 hits less then | 13.85 lbs | 1.403 inches |
| | | 8″ apart at 15′ | | |
| Bravo Class. 1.305. NS-PC | 5.56 AP-NATO Round | 1 hit at 15 feet | 10.65 lbs | 1.305 inches |
| Bravo Class. 1.305. NS-PC | AK 47 | 3 hits at 15 feet | 10.65 lbs | 1.305 inches |
| Bravo Class. 1.5. NS-PC | AK 74 | 5 hits at 15 feet | 11.37 lbs | 1.5 inches |
| Bravo Class. 1.5. S-SGP | 7.62 NATO M-80 Ball | 3 hits at 15 feet | 10.6 lbs | 1.5 inches |
| Bravo Class. 1.7. S-SGP | 7.62 NATO M-80 Ball | 5 hits at 15 feet | 18.52 lbs | 1.7 inches |
| Bravo Class. 1.745. NS-PC | 7.62 NATO M-80 Ball & | 13 Hits 3-4″ | 17.13 lbs | 1.745 inches |
| | AK47 | apart at 15 feet | | |
| Delta Class. 1.745. NS-PC | 300 Winchester Mag | 2 hits 4″ apart at | 17.13 lbs | 1.745 inches |
| | | 15 feet | | |
| Delta Class. 1.745. NS-PC | 300 Weatherby Mag | 9 hits 6″ apart at | 17.13 lbs | 1.745 inches |
| | | 15 feet | | |
| Delta Class. 1.950. NS-PC | 30.06 AP | 1 hit at 15 feet | 22.31 lbs | 1.95 inches |
| Delta Class. 1.950. NS-PC | 7.62 AP | 3 hits 8″ apart at | 22.31 lbs | 1.95 inches |
| | | 15 feet | | |
| Delta Class. 1.850. NS-PC | 0.30 Cal AP | 1 hit at 15 feet | 21.42 lbs | 1.85 inches |
| Tango Class. 2.0. NS-PC | 0.50 cal NATO Ball | 1 hit 100′ by 36″ | 20 lbs | 2.05 inches |
| | FMJ 700 Grs. | barrel | | |
| Tango Class. 2.356. NS-SGP | 0.50 cal NATO Ball | 1 hit 100′ by 28″ | 28.23 lbs | 2.3 inches |
| | FMJ 700 Grs. | barrel | | |
| Tango Class. 2.8. NS-PC | 0.50 cal API/PPI | 1 hit 75 yds by | 28.88 lbs | 2.6 inches |
| | Athena-FN USA | 28″ barrel | | |
| Tango Class. 3.1 NS-PC | 0.50 cal API NATO | 2 hits 75 yds by | 33.16 lbs | 3.4 inches |
| | Silver Tip | 28″ barrel | | |
| Tango Class. 3.55 NS-PC | 0.50 cal API-LaMas | 3 hits 8″ apart | 37.22 lbs | 3.55 inches |
| | Urban SWAT | 28″ Barrel 100′ | | |

The empirical data presented by Table 1 demonstrates that the attribute of effective penetration-resistance does exist in fact as a distinct and demonstrable property for a range of different composite materials; and identifies a variety of diverse substances able to resist penetration after being impacted by high-velocity projectiles. However, one particular feature and parameter shared in common by each of these tested laminated composites stands out—the thicknesses of the individually formulated laminated composites.

Attention is therefore directed to the thickness dimension data for each of the individually formulated laminated formulations presented by Table 1. It will be noted that the minimal thickness of the formulated laminated composite useful as an anti-ballistic window, door, or dome is 0.50 inches; that the thickness dimension of the individually formulated laminated composites increase markedly as their respective penetration-resistance values increase; and that the greatest penetration-resistance is provided by an individually formulated laminated composite which is 3.55 inches in thickness.

The undisputed fact is thus empirically established via the data of Table 1 above that: (a) penetration-resistance is a property which will vary as a function of and will increase in accordance with the thickness of the formulated laminated composite; (b) a minimal thickness in the order of 0.5 inches is typically required for a formulated laminated composite to show penetration-resistance properties; and (c) the greater the thickness dimension of the laminated composite, the greater the penetration-resistance properties for that individually formulated laminated composite.

### The Problematic Consequences

What is not immediately recognized, however, is that when such laminated composite plates are used as anti-ballistic windows, doors and domes, the conventional wiper arm assembly of the vehicle cannot accommodate nor functionally adjust to transparent panels and panes which exist in thickness and girth to such a degree. Typically, it is only afterward actual installation of the anti-ballistic windows, doors, and domes onto the vehicle body that it becomes apparent that the conventionally known and used system of wiper arms has become inoperative and can no longer serve any useful purpose—because the anti-ballistic window, door or dome in the vehicle now has a thickness dimension which ranges from about 0.5 to 3.55 inches or more.

The military personnel are thus faced with a dire dilemma: Either remove the anti-ballistic plates from the vehicle—thereby leaving the occupants of the vehicle open to serious injury or death owing to the absence of any penetration-resistance capacity in the windows and doors and domes of the vehicle; or retain the installed anti-ballistic windows, doors, and domes in the vehicle for the protection of its occupants from gunfire and explosions, but consequently also leaving the vehicular occupants without any means of clearing or removing dirt and obstructions from the exterior surfaces of the vehicular visual viewing zones while in hazardous and/or combat circumstances. Given these limited options, military personnel always have preferred the latter choice.

For these reasons, one can now properly understand and acknowledge both the nature as well as the seriousness of the true underlying problem. Clearly, there is a newly recognized and only recently appreciated need for a different and improved wiper arm structure that addresses and overcomes these specific problems.

### SUMMARY OF THE INVENTION

The present invention addresses the aforementioned shortcomings, and benefits the user by providing a novel and unique wiper arm extension. A major feature and distinct advantage of the instant wiper arm extension is that it intends and allows the use of the original equipment wiper motor and controls then present in the vehicle, despite the fact that the anti-ballistic window, door or dome will now typically vary from 0.5 to 3.55 inches or more in thickness. In its minimal embodiments, the invention comprises only three component parts: (i) an extended flange; (ii) an extended crank arm; and (iii) an optionally present support bracket

### BRIEF DESCRIPTION OF THE DRAWINGS

Exemplary embodiments of the present invention will now be described by way of illustration and with reference to the accompanying example drawings in which:

FIG. 1 shows a forward view of the wiper arm extension after it has been assembled and secured to the original equipment motor and controls of a vehicle; and

FIG. 2 shows the manner of attachment of the wiper arm extension to the wiper motor arm view of the vehicle

### DETAILED DESCRIPTION OF THE INVENTION

### I. The Overall Scope of the Present Invention

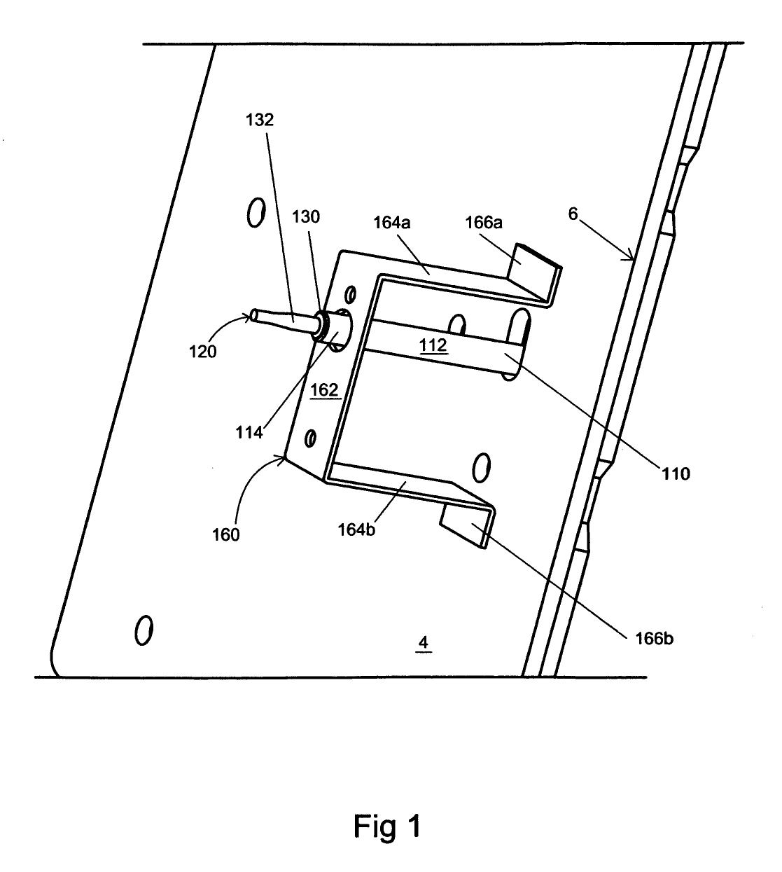

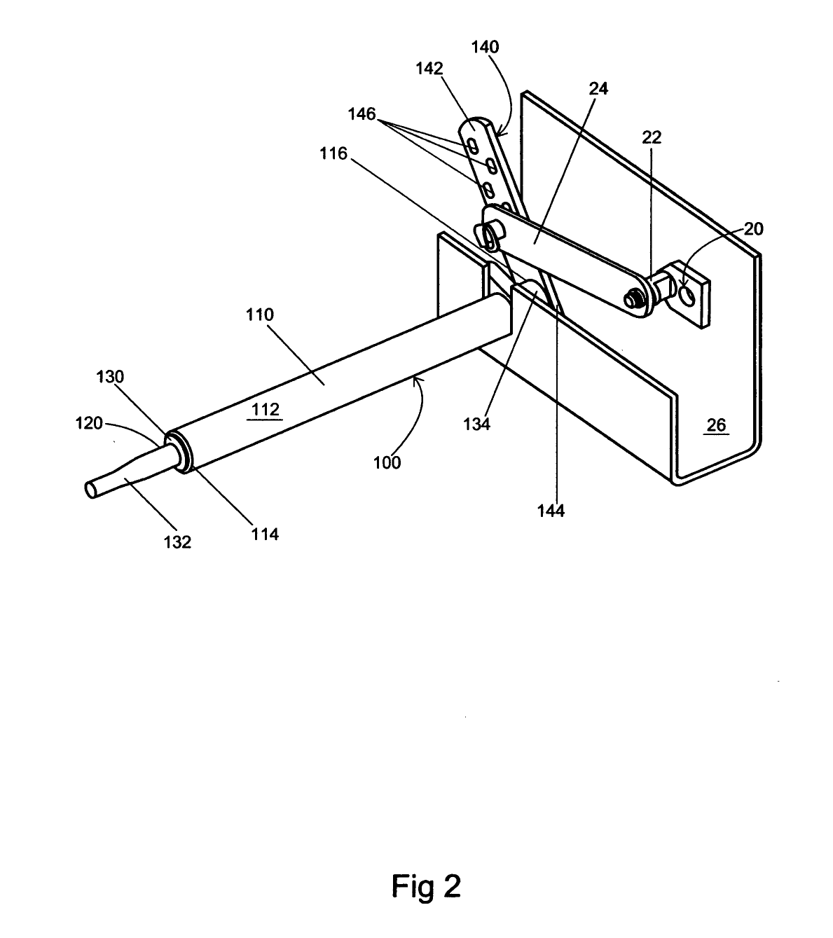

The present invention—an improved wiper arm extension for an anti-ballistic viewing window, door, or panel installed in a military or combat vehicle—can be prepared in multiple embodiments and may take tangible form in a variety of alternative constructions. It will be expressly understood and appreciated also that, although the embodiment illustrated by FIGS. 1 and 2 respectively hereof focuses attention upon wiper arm extensions suitable for anti-ballistic windows, doors and domes generally, the present invention overtly encompasses and clearly includes any visual viewing sheet, panel, article, or design; and encompasses and includes such discrete articles as a viewable observation roof, a front windshield, observation sidewalls, a viewing rear wall, and viewable observation doors which constitutes part of a car, truck, or other transport vehicle suitable for use in combat circumstances and/or other hazardous circumstances.

It will be recognized also that the instant invention presumes the prior existence and availability of a motorized vehicle having at least one pre-existing solid support, frame or wall upon which the improved wiper arm extension can be disposed and fitted adjacent to the anti-ballistic window or other viewing area; and that the pre-existing vehicular supporting framework will provide and include at least one open spatial zone (of preset dimensions and configuration) which serves as a volumetric open space or portal for the installation of a transparent or translucent anti-ballistic window, pane or panel. Thus, the specific format of and tangible presence for any pre-existing vehicular member, support, frame, or wall includes every conventionally known, manufactured, built, and/or used structure and component having a discrete width, length and height dimension; and any tangible object which encloses, protects, divides a space, or supports a portion of the vehicle.

Moreover, any manner, shape, or style of anti-ballistic viewing or visual zone which may be present in the pre-existing vehicle can be accommodated by the present invention. Thus, the individual visual viewing zones may differ in length, width and height; be geometric or non-geometric in configuration; be concave or convex in orientation; have uniform or non-uniform curves and bends; be regular or irregular in pattern; be sculpted or non-sculpted; and be fashioned as the result of template or non-template forms.

Finally, in the most common instances, the pre-existing solid support, frame, or wall will typically be a part of a motorized vehicle which has a solid (typically metal) body shell; and has one or more arranged internal compartments, seating areas, roofs and doors delineated by walls having surfaces formed of hard outer materials (usually metal alloys). The anti-ballistic windows, doors, dome, and/or other viewing panels typically will have been previously joined and secured to the external (and preferably internal) wall surfaces of the vehicular body shell, sidewalls, roofs, and doors.

### Definitions, Titles & Terminology

To provide greater clarity and ease of comprehension, as well as to avoid ambiguities in wording and a confusion of nomenclature, the following titles, terms and definitions are provided. As concerns the description and details of the present invention, the following terms, definitions, and meanings are employed routinely and consistently.

The terms “Composite and composite material” as used herein refers to a formulated composition or prepared substance composed of different chemical constituents which are combined or blended together to form a single synthetic compound having certain physical attributes and/or chemical properties.

The terms “Laminate and laminated composite” as used herein refers to at least one stack and usually multiple discrete stacks of matter joined together in sequence, which form a unified entity and single article of manufacture.

The term “Plate” as used herein refers to a pane, panel or slab of determinable dimensions, configuration, volume, and mass which is prepared and exists as a laminated construct formed as multiple layers of composite materials. The plates may be flat surfaced to be deployed in an appropriate frame, or be rounder on the sides and top, so long as the supporting framework can accommodate the alternative plate shapes. Examples of plate capacity to resist high velocity projectile penetration are presented by Table 1 above.

The terms “Asymmetric and asymmetry” as used herein refers to a physical property and dimensional attribute of matter which describes the individual thickness (or girth) for either a layer, or a substrate, or a stack of matter which may exist as part of the laminated composite, and where the thickness of one specific material layer, substrate, or stack within the laminate composite varies, is non-uniform, or is different from other individual layers, substrates, or stacks present in the composite as a whole.

The terms “Penetration-resistance (and of being penetration-resistant)” as used herein refers to the physical property and attribute of a material to withstanding being pierced, split or fragmented and to prevent being penetrated by the impact force of a moving object traveling at a measurable rate of speed.

The term “High velocity” as used herein refers to a Projectile with a rate of speed in the range from approximately 1500 to 9000 (or more) feet per second (fps).

The terms “Explosion fragments” as used herein refers to any type of high velocity projectiles whose speed is generated by an explosion or an explosive force.

The term “Opaque” as used herein refers to a material which is totally absorbent of visible light rays of a specified wavelength and thus fails to allow visibility when viewing through the material from one side to the other.

The term “Transparent” as used herein refers to a material which allows the visible light rays of a specified wavelength to pass without substantial absorption and thus allows visibility when viewing through the material from one side to the other.

The term “Translucent” as used herein refers to a material which is capable of transmitting light, but through which no image or object can be seen.

### II. The Inventive Subject Matter as a Whole

The present invention as a whole is a wiper arm extension subassembly which allows the use of the military vehicle's original equipment wiper motor system and controls; and presumes that one or more anti-ballistic sheets, panes or panels having a thickness dimension not less than 0.5 inches in size are to be or have been installed as a window/windshield in the vehicle. In its minimalist form, the present invention comprises only two essential component parts: (i) an extended flange; and (ii) an extended crank arm. In addition, a third item, an optionally present support bracket, may be advantageously employed. The erected subassembly and the use of these components is illustrated by FIGS. 1 and 2 respectively.

In its preferred embodiments, the wiper arm extension will replace the original wiper and arm equipment of the vehicle. This change is achieved by mounting the combined extended flange and crank arm to the pre-existing motor arm system of the vehicle in the same approximate location; and by employing the extended length of the combined flange and crank arm over a greater (longer) distance to account for and accommodate the larger thickness dimension of the anti-ballistic windows, windshield, doors, dome, or other visual viewing plates.

As illustrated by the figures, the integrated extended flange and extended crank arm of the wiper arm extension subassembly is a complete replacement and unique substitute for the original equipment wiper arm of the vehicle. The present wiper arm extension subassembly is to be mounted to the pre-existing motor arm linkage bar of the vehicle in the same location; and is pre-chosen to be sufficiently long in its dimensions to match and accommodate the actual thickness dimension of the anti-ballistic window/windshield then in place for the particular vehicle. In addition, the wiper arm extension subassembly allows an ordinary and conventionally known wiper blade to be mounted to it.

It is noted that the present invention comprises only two necessary components which are integrated together as a unit: an extended flange; and an extended crank arm. One feature of the extended crank arm of the subassembly is its perpendicularly disposed lever handle, which provides multiple mounting/alignment holes suitable for on-demand attachment to the pre-existing motor arm linkage. This arrangement of multiple mounting/alignment holes allows for a greater degree of adjustment for the stroke of the wiper arm, since the anti-ballistic window typically has far larger dimensions than the shatterable-glass original window.

Optionally but desirably, the invention will also include a shortened motor arm linkage bar that serves as a complete replacement for the original wiper motor arm, if and when necessary. This shortened wiper motor arm will produce a shortened reciprocal stroke for the wiper assembly, an entirely optional addition to the present invention if the holes in the extended flange do not themselves allow for adequate mounting and adjustment to the motor arm linkage. The original equipment idler arm plate is then mounted to the substitute shortened motor arm linkage bar, and in this manner becomes joined to the wiper arm extension subassembly.

### III. Prepared Kits Produced In Advance

Each and every embodiment of the present invention is intended to be both portable and transportable on demand to a particular geographic site or locale whenever and as needed. In certain versions and formats of the kit, the individual component parts constituting the kit as a whole will be based upon and in compliance with specified measurements or particular engineering specifications, and/or exact drawings; and, at least in these instances, the prepared kit components will rely completely upon these previously given specifics and particulars.

It is also intended and expected that one major commercial format and manner of sale for the present invention will be as follows: The individual components comprising the improved wiper arm extension will be separately manufactured; and the individual components will then be packaged together as prepared kits which can be stored in bulk quantities as inventory; and when needed, a chosen number of the prepared in advance kits will then be sent to and subsequently used either by the actual purchaser or the intended personnel.

Accordingly, every produced-in-advance kit will comprise and include at least an extended flange; an extended crank arm; and a support bracket. Also included within each kit are specific means and articles for installing the components at the ultimate site of need or at a particular location. When and as needed, however, the prepared kits may also include any number of other useful articles such as specific tools, screws of various sizes, new wiper blades, and any other object or device deemed desirable or necessary for installation of the component parts.

In addition, the produced-in-advance kits are envisioned and expected to be warehoused as accumulated inventory and then subsequently delivered upon demand, order, or sale, as well as in accordance with a preset time schedule. In this manner, the proper kind and number of prepared kits will be available to meet the needs of the individual buyer or user, or to satisfy the particular nuances of a particular project; and will comply with the particular specifications and other requirements set forth by outside parties, private or government contracts, and authorized project coordinators. Quality control, including project testing, is also contemplated as necessary to meet the demands or expectations of the prospective purchaser.

In addition, there are expected and intended to be a wide range of prepared kits produced in advance to meet a large variety of different use demands and contingencies; and each kind of produced in advance kit will, in turn, be sold and delivered to the actual purchaser or intended user, through conventional sales methods, distribution and warehousing systems, and common transportation carriers to the given mailing address or indicated geographic location for installation by the available personnel.

Accordingly, the present invention is not limited to the preferred embodiment disclosed, but is intended to cover all modifications that are within the spirit and scope of the invention as defined by the appended claims. Further, because the detailed description of the preferred embodiment of the invention fully reveals the general nature of the invention, it is expected that others can readily modify and/or adopt each of the required components for various purposes without meaningfully departing from the general inventive concept; and therefore all such adaptations and modifications are deemed to lie within the expected range of equivalents of the disclosed embodiment.

### IV. A Preferred Embodiment

A preferred embodiment of the present invention is illustrated by FIGS. 1 and 2 respectively. FIG. 1 shows a forward view of the wiper arm extension after it has been assembled and secured to the original equipment motor and controls of a vehicle; while FIG. 2 shows the manner of attachment of the wiper arm extension to the wiper motor arm view of the vehicle. For greater ease of understanding, the detailed description of the instant invention will utilize both FIGS. 1 and 2 concurrently.

While the invention has been previously described herein in some detail for purposes of clarity and understanding, the particular embodiment and example presented below is to be considered as merely illustrative and not restrictive. It will be appreciated by one skilled in the art that various changes in form and detail can be made for the invention without departing from its true scope.

### A Pre-Existing Conventional Wiper Motor Assembly

As illustrated by FIGS. 1 and 2 respectively, the present invention presumes the pre-existence of an armored military vehicle having at least one anti-ballistic plate window installed as a windshield; and also presumes that a conventional wiper motor assembly 20 and conventional wiper motor controls (not shown) are positioned upon the exterior surface of the vehicle, which then also continue into the vehicle's interior compartment. The pre-existing wiper motor system 20 includes a wiper motor (found typically inside the vehicle's compartment), an externally exposed short length wiper motor arm 22, an externally exposed motor arm linkage bar 24, and an externally exposed wiper motor bracket 26 which is fixed in position on an exterior surface of the military vehicle. This arrangement of and organization for the wiper motor system 20 is entirely conventional, and typically constitutes part of the original manufacturer's equipment for the military vehicle.

The present invention is a subassembly which is joined to the pre-existing wiper motor system 20, and allows the use of the original equipment wiper motor and controls then present in the vehicle, despite the fact that the anti-ballistic window/windshield can range from 0.5 to 3.55 inches or more in thickness. FIGS. 1 and 2 illustrate a minimal embodiment of the assembled and attached invention, a wiper arm extension subassembly 100 which comprises only three component parts: an extended flange 110; an extended crank arm 130; and an optional support bracket 160.

### The Extended Flange Component

The extended flange 110 is a hollow cylindrically-shaped tube 112 having two open ends 114, 116; a preset internal diameter and spatial lumen; and an overall length which is set in advance and is sufficient in size to extend beyond the thickness of the anti-ballistic window/windshield then present in that military vehicle. Thus, if the thickness of the anti-ballistic window/windshield is the minimal 0.5 inches, then the length of the extended flange 110 will typically be about 1-2 inches; similarly, if the thickness of the anti-ballistic window/windshield is 3.5 inches or more, then the overall length of the extended flange 110 will typically be about 4-5 inches in size. The length dimension for the extended flange 110 will generally be a function of and vary with the thickness of the anti-ballistic window/windshield.

The extended flange 110 is typically formed of a hard durable metal or metallic alloy; is a material having a durable gauge; and is most preferably formed of hardened aluminum. It will also be understood that the extended flange 110 serves as a complete replacement for the original manufacturer's equipment flange, which is far too short to accommodate even a minimal thickness of the anti-ballistic window/windshield of that vehicle.

### The Extended Crank Arm Component

The second component of the subassembly 100 comprises two parts; the extended crank arm 120 which comprises an elongated crank shaft 130, and a perpendicularly attached lever handle 140. The extended crank arm 120 serves as an elongated axel which is bent at a right angle for interconverting reciprocal and circular motions. For these reasons, the elongated crank arm 120 will typically be a solid article formed of a hard durable metal or metallic alloy; and in the most preferred embodiments will be composed of steel.

(i) The Elongated Crank Shaft

As shown by FIGS. 1 and 2, the elongated crank shaft 130 is a cylindrically-shaped solid having a fixed overall length, girth, and outer diameter. The distal end 132 of the elongated crank shaft 130 is preferably tapered at the tip and is suitable for fitting with a replaceable wiper blade (not shown). In contrast, the proximal end 134 of the elongated crank shaft 130 is typically blunt-ended for permanent juncture to and attachment of the lever handle 140.

It will be recognized and appreciated that the overall length of the elongated crank shaft 130 will always be greater than the dimensional length of the extended flange 110; and that the outer diameter size of the elongated crank shaft 130 will always be smaller than the internal diameter size of the extended flange 110. This diameter size relationship between the elongated crank shaft 130 and the extended flange 110 is necessary and required because the substance of the crank shaft 130 is to pass through the entirety of the internal lumen of the extended flange 110; and once having been inserted and passed through, the crank shaft body must be freely rotable on-demand while positioned within the internal lumen of the extended flange 110.

Furthermore, when the elongated crank shaft 122 is inserted into and passes internally through the hollow lumen and linear length of the extended flange 110, it is intended that the tapered end 132 will appear unobstructed and exposed to the ambient environment; and that the tapered end 132 will extend a short distance beyond the end 114 of the extended flange 110.

(ii) The Lever Handle

In comparison, the lever handle 140 of the extended crank arm 120 is a substantially planar bar or strip having predetermined length, width, and depth dimensions; two discrete handle ends 142, 144; and a plurality of alignment holes 146, each of which is individually located at a pre-chosen position over the linear length of the handle 140. The alignment holes 146 are used for subsequent attachment of the lever handle 140 to the conventional motor arm linkage bar 24 pre-existing in the vehicle. For these reasons, the lever handle 140 is typically formed of a hard durable metal or metallic alloy; and in the most preferred embodiments will be fashioned from steel.

The lever handle 140 has been permanently joined to the blunt end 134 of the crank shaft 130, at preferably a substantially perpendicular angle, using any conventionally known means and manner of secure attachment. As a consequence of such angular attachment and juncture, the perpendicularly joined lever handle 140 will serve to convert a reciprocal motion into a circular motion, which is then transferred and applied to the body of the extended crank shaft 130 as it lies within the extended flange 110.

The event of converting reciprocal motion into circular motion is achieved when the lever handle 140 (then permanently joined to the blunt end 134 of the crank shaft 130) is joined via one or more of the alignment holes 146 to the pre-existing motor arm linkage bar 24. Such attachment via the alignment holes 146 is shown in FIG. 2.

It will be recalled that the pre-existing wiper motor system 20 includes a wiper motor (found typically inside the vehicle's compartment), an externally exposed short length wiper motor arm 22, an externally exposed motor arm linkage bar 24, and an externally exposed wiper motor bracket 26 which is then fixed in position on an exterior surface of the military vehicle. Thus, when engaged in normal operation, the motor arm linkage bar 24 of the pre-existing wiper motor system 20 will rotate back and forth, and thereby provide a recurring reciprocal motion. This reciprocal motion inn turn is converted into a circular motion by the attached lever handle 140; and the generated circular motion is applied directly to the body of the crank shaft 130, and the tapered end 132 then extending beyond the end 114 of the extended flange 110.

It will be recognized also that the mode and manner of attachment by which the lever handle 140 becomes physically joined to the motor arm linkage bar 24 of the pre-existing wiper motor system 20 is of no consequence or importance. Thus, removable mechanical aids such as nuts and bolts, machine screws and closures, as well as juncture pins and picks are quite suitable for forming an attachment to the motor arm linkage bar 24 whenever required; and, in the alternative, more permanent attachment techniques such as soldering, welding and the like are also available whenever needed or desired by the user.

As an optional, but very desirable feature, the invention will also provide a shortened motor arm linkage bar that serves as a complete replacement and substitute for the original motor arm linkage bar, if and when necessary. The shortened length of the substitute motor arm linkage bar will produce a shortened reciprocal stroke for the pre-existing wiper motor assembly; and is available as an entirely optional addition to the present invention if the user finds that the mounting/alignment holes in the lever handle do not alone allow for an adequate mounting and a proper distance adjustment to the motor arm.

### The Optionally Present Support Bracket

The third and final component of the subassembly 100 is the optional support bracket 160, which is illustrated by FIG. 1. As seen therein, the support bracket 160 serves as a mechanical aid to help maintain the combined extended flange 110 and extended crank arm 130 in proper position, after they have been joined to the conventional motor arm linkage bar 24.

The support bracket 160 is a solid strip of metal or metallic alloy which has been fashioned into a substantially rectangularly-shaped or U-shaped structure; and which provides a passageway and physical support for the extended flange 110 and extended crank arm 130 in combination. When present, the support bracket 160 typically has a narrow top portion 162, two side walls 164a, 164b; and two footings 166a, 166b. Within the top portion 162, there is at least one aperture 164 through which the combined extended flange 110 and extended crank arm 130 pass.

As illustrated by FIG. 1, the support bracket 160 is to be mounted on an exterior surface 4 of the military vehicle 6 adjacent to the motor arm linkage bar 24 via the two footings 166a, 166b; and once properly in position, the aperture 164 allows the combined extended flange 110 and extended crank arm 130 to pass through without either difficulty or obstruction. The function and purpose of the support bracket 160 is to stabilize and maintain the proper orientation for the distal end of the combined extended flange 110 and extended crank arm 130. However, it will be clearly understood that the support bracket 160 is solely and completely an optional component—but a very desirable one that will add markedly to the value and longevity of the invention during its use.

The present invention is not to be restricted in form nor limited in scope except by the claims appended hereto.

What I claim is:

1. An extended wiper arm subassembly comprising:
an extended flange formed as a hollow cylindrically-shaped tube having two open ends, a preset internal diameter and spatial lumen, and an overall length which is set in advance and is sufficient in size to accommodate the thickness of an anti-ballistic window/windshield then present in a military vehicle; and
an extended crank arm which has been passed into and through the spatial lumen of said extended flange, wherein said crank arm serves as an elongated axel which is bent at about a right angle for interconverting reciprocal and circular motions, and is comprised of
(i) an elongated crank shaft which is substantially cylindrically-shaped and has a fixed overall length, girth, and outer diameter, and
(ii) a lever handle which is a substantially planar bar having predetermined length, width, and depth dimensions, two discrete handle end, and a plurality of alignment holes individually located at pre-chosen positions over the linear length of said planar bar.

2. The extended wiper arm subassembly as recited in claim 1 further comprising an optionally present support bracket.

3. The extended wiper arm subassembly as recited in claim 1 further comprising a shortened motor arm linkage bar.

4. A prepared in advance kit for mounting an extended wiper arm subassembly to a pre-existing wiper motor system of a military vehicle which includes a wiper motor, an externally exposed short length wiper motor arm, and an externally exposed motor arm linkage bar, said kit comprising:
an extended flange formed as a hollow cylindrically-shaped tube having two open ends, a preset internal diameter and spatial lumen, and an overall length which is set in advance and is sufficient in size to accommodate the thickness of an anti-ballistic window/windshield then present in a military vehicle;
an extended crank arm which has been passed into and through the spatial lumen of said extended flange, wherein said crank arm serves as an elongated axel which is bent at about a right angle for interconverting reciprocal and circular motions, and is comprised of
(i) an elongated crank shaft which is substantially cylindrically-shaped and has a fixed overall length, girth, and outer diameter, and
(ii) a lever handle which is a substantially planar bar having predetermined length, width, and depth dimensions, two discrete handle end, and a plurality of alignment holes individually located at pre-chosen positions over the linear length of said planar bar; and
means for mounting said lever handle of said extended crank arm to an externally exposed motor arm linkage bar.

5. The prepared kit as recited in claim 4 further comprising an optionally present support bracket.

6. The prepared kit as recited in claim 4 further comprising a shortened motor arm linkage bar.
